(19) United States
(12) Patent Application Publication
(10) Pub. No.: US 2018/0351700 A1
(43) Pub. Date: Dec. 6, 2018

(54) Convolutional code data sending method and apparatus

(71) Applicant: ZTE CORPORATION, Shenzhen (CN)

(72) Inventor: Jin Xu, Shenzhen (CN)

(21) Appl. No.: 15/759,792

(22) PCT Filed: Aug. 29, 2016
(86) PCT No.: PCT/CN2016/097239

§ 371 Date: Mar. 13, 2018

(30) Foreign Application Priority Data
Sep. 14, 2015 (CN) 201510582298.6

(51) Int. Cl. H04L 1/00

(52) U.S. Cl. CPC H04L 1/0059; H04L 1/0071; H04L 1/0041

(57) ABSTRACT

Disclosed are a convolutional coded data sending method and apparatus. The method comprises: coding data bits of an input information block with convolutional codes, and combining the coded data bits into a circular buffer region; determining a starting position where data bits forming a to-be-transmitted data packet are read in the circular buffer region; and reading, from the starting position, the data bits having a specific length column by column in a column sequence to form the to-be-transmitted data packet, and sending the to-be-transmitted packet. The convolutional code data sending method and apparatus disclosed in the present invention can generate a to-be-transmitted data packet of a convolutional code having a flexible code rate.

### TECHNICAL FIELD

The present disclosure relates to the field of digital communications, and particularly to a convolutional-code-based data sending method and device.

### BACKGROUND

FIG. 1 is a schematic diagram of an existing digital communication system. As shown in FIG. 1, in the digital communication system, a sender usually includes parts such as an information source, an information source coder, a channel coder and a modulator, and a receiver usually includes a demodulator, a channel decoder, an information source decoder and an information sink. The channel coder is arranged to introduce redundant information for information bits according to a certain rule to enable the channel decoder of the receiver to correct an error code generated when information is transmitted on a channel to a certain extent.

At present, in numerous channel coding technologies, convolutional code is one of forward error correction coding which is widely applied. In case of a medium/short code length, error correction performance of a convolutional code is high, and a codec is simple in structure, so that convolutional code is usually arranged to code data information of some medium/low-bandwidth wireless communication systems (for example, a Global System for Mobile Communication (GSM) and a Worldwide Interoperability for Microwave Access (Wimax) system) or control information of a wideband wireless communication system (for example, a Long Term Evolution (LTE) system). In addition, since hardware cost of convolutional code is relatively low, convolutional code is also used for a fixed wireless wideband system (for example, a Wireless-Fidelity (WIFI) system) as a data information coding manner.

A convolutional code is usually described with a rate, a constraint length and a generator polynomial. In a convolutional code coder, each input bit passes through a shift register, so that a number of output bits generated by the coder corresponds to a number of the input bits and a rate of the coder. A convolutional code coding method is to initialize each shift register (for example, forcible resetting to a zero state) with zero to refresh the coder with a “tail bit” and add the tail bit at the end of the input data bits as a tail. However, this may increase a frame length, thereby reducing a practical transmission rate. For avoiding reduction in the rate, a tail-biting convolutional code may be adopted, a shift register of the tail-biting convolutional code is initialized with last several bits of input data, and in such a manner, the coder still ensures that starting and ending states of the shift register are the same. A convolutional code adopted for an LTE system and the like is a tail-biting convolutional code.

FIG. 2 is a structure diagram of a convolutional code coder adopted for an LTE system. As shown in FIG. 2, an initial value of a shift register of the coder is set to be a value corresponding to last 6 information bits of input data, so that initial and final states of the shift register are the same. A tail-biting convolutional code coder with a rate of 1/3 is shown in FIG. 2, there is one piece of input Cₖ, and generator polynomials corresponding to three output ports are as follows: G0=133 (octal), G1=171 (octal) and G2=165 (octal).

In an ordinary digital communication system, when a modulation and coding scheme is designed, modulation manners of different orders (for example, Quadrature Phase Shift Keying (QPSK), 16 Quadrature Amplitude Modulation (QAM) and 64QAM) and different rates (for example, 1/2, 2/3, 3/4 and 5/6) are usually set. During system scheduling, a specific modulation and coding scheme is arranged for each burst according to channel quality and a service requirement. For achieving a better link adaptation effect, a relatively small granularity is required to be achieved as much as possible when the rate is changed for each type of codes.

For data information coding, a low-code-rate parent code is punctured to obtain a higher-code-rate code, and such a method is summarized into Rate Matching (RM). For a modern communication system such as LTE, the system is also required to support a Hybrid Automatic Repeat reQuest (HARQ) process by RM. However, HARQ of LTE is only for data information coded by adopting a Turbo code, and a HARQ function is not supported by control information coded by adopting a convolutional code.

HARQ is an extremely important link adaptation technology in a digital communication system. A receiver decodes a received HARQ data packet, feeds back an Acknowledgement (ACK) signal to a sender to notify it to send a new HARQ data packet in case of a decoding success, and in case of a decoding failure, feeds back a Negative Acknowledgement (NAK) signal to the sender to request the sender to resend the HARQ data packet. The receiver performs Increasing Redundancy (IR) or Chase combined decoding on a data packet which is retransmitted for many times, so that a decoding success probability may be increased, and a requirement on high reliability of link transmission may be met.

Along with vigorous development of novel applications such as the Internet of things, developing an LTE-standard-based small-data-volume wireless communication technology on a narrow bandwidth of about 200K gradually becomes one of hotspot requirements. If a convolutional code is transplanted into a data channel of a narrowband LTE system to replace an expensive Turbo code, functions of reducing cost of Internet of things equipment and reducing energy consumption may be realized. However, a present LTE standard does not support convolutional-code-based HARQ. Although some other communication systems, for example, a Wimax system, support convolutional-code-based HARQ, their RM adopts some fixed puncturing pattern perforation manners, HARQ sub-packets with fixed rates such as 1/2, 2/3, 3/4 and 5/6 may be generated only, and RM manners are not so flexible.

In addition, for enhancing coverage of a narrowband Internet of things system, information data may also be considered to be repeatedly transmitted for many times after being coded, which may enhance a received signal. A difference from HARQ is that repeated transmission does not require a receiver to feed back any ACK or NAK signal. A similarity is that the receiver is also required to perform combined decoding. How to reasonably select a data packet to be transmitted each time to achieve a more flexible rate and higher performance after combination by the receiver is a problem required to be solved, like a HARQ scenario.

### SUMMARY

In order to solve the technical problem, the disclosure provides a convolutional-code-based data sending method and device, which may generate a convolutional-code-based data packet to be transmitted with a flexible rate.

In order to achieve the technical purpose, the disclosure provides a convolutional-code-based data sending method. The method includes the following actions. Convolutional code coding is performed on data bits of an input information block, and the coded data bits form a circular buffer. A starting position for reading, from the circular buffer, data bits forming a data packet to be transmitted is determined; and data bits of a specific length are read column by column from the starting position according to a sequence of the columns to form a data packet to be transmitted, and the data packet to be transmitted is sent.

According to an embodiment, the action of performing convolutional code coding on the data bits of the input information block and the coded data bits form the circular buffer may include the following actions. Convolutional code coding is performed on the data bits of the input information block, and r check bit streams are output, where r may be an integer more than or equal to 2. The r check bit streams resulting from convolutional code coding are input into sub-block interleavers with a same size. Inter-column rearrangement is performed on the check bit streams input into each sub-block interleaver according to a given rearrangement vector respectively.

According to an embodiment, after the action of performing inter-column rearrangement on the check bit streams input into each sub-block interleaver according to the given rearrangement vector respectively, the method may include the following action. Bit interleaving is performed on t rearranged check bit streams, where t may be a positive integer, and 2≤t≤r.

According to an embodiment, the action of determining the starting position for reading, from the circular buffer, the data bits forming the data packet to be transmitted may include the following actions. The starting position for reading, from the circular buffer, the data bits forming the data packet to be transmitted is determined according to a redundancy version value corresponding to the data packet to be formed and transmitted. Or, the starting position for reading, from the circular buffer, the data bits forming the data packet to be transmitted is determined according to data packets which have been sent. Or, the starting position for reading, from the circular buffer, the data bits forming the data packet to be transmitted is determined according to a transmission sequence corresponding to the data packet to be transmitted.

According to an embodiment, the action of determining the starting position for reading, from the circular buffer, the data bits forming the data packet to be transmitted is determined according to the redundancy version value corresponding to the data packet to be formed and transmitted may include the following actions. When there are Nᵣᵥ redundancy version values corresponding to the data packet to be transmitted, the starting position is determined to be

$${k}_{0} = {R}_{subblock} \cdot [ A \cdot Operation ( \frac{{N}_{cb}}{{R}_{subblock} \cdot {N}_{rv} \cdot A} \cdot {rv}_{idx} ) ] ,$$

where R_{subblock} denotes a number of rows of the sub-block interleaver, N_{ch} denotes a size of the circular buffer, Nᵣᵥ denotes a number of the redundancy version values, Nᵣᵥ is a positive integer, rv_{idx} denotes the redundancy version value, rv_{idx} is valued from a set {0, 1, K Nᵣᵥ−1}, Operation(•) denotes a rounding operation which may be rounding-up, rounding-down or rounding-off, and A may denote a constant positive integer.

According to an embodiment, a redundancy version value corresponding to a data packet transmitted for the first time may be rv_{idx}=0.

According to an embodiment, the action of determining the starting position for reading, from the circular buffer, the data bits forming the data packet to be transmitted according to the data packets which have been sent may include the following actions. When the current data packet to be transmitted is a data packet to be transmitted for the nth time and a length of data packets which have been sent for the last n−1 times is Ei, the starting position of the data bits of the current data packet to be transmitted is determined to be k₀=R_{subblock}·mod(Cₙ₋₁,(r·C_{subblock})), where R_{subblock} denotes the number of rows of the sub-block interleaver, C_{subblock} denotes a number of columns of the sub-block interleaver, r is a number of the bit streams resulting from convolutional code coding, mod(•) denotes a remainder calculation operation, Cₙ₋₁ denotes a number of columns of the circular buffer corresponding to the data packets which have been sent for the last n−1 times,

$${C}_{n - 1} = {\sum }_{i = 1}^{n - 1} ⌈ \frac{{E}_{i}}{{R}_{subblock}} ⌉ , or , {C}_{n - 1} = {\sum }_{i = 1}^{n - 1} ⌈ \frac{{E}_{i}}{{R}_{subblock}} ⌉ - n + 1 ,$$

where n and i may be positive integers, 1≤i≤n−1, and F┌ ┐ may represent a rounding-up operation.

According to an embodiment, the action of determining the starting position for reading, from the circular buffer, the data bits forming the data packet to be transmitted according to the transmission sequence corresponding to the data packet to be transmitted may include the following actions. When the current data packet to be transmitted is the data packet to be transmitted for the nth time, when n is an odd number, the starting position of the current data packet to be transmitted is determined to be a first significant bit of the circular buffer; and when n is an even number, the starting position of the current data packet to be transmitted is determined to be a first significant bit of a central column of the circular buffer, where n is a positive integer.

According to an embodiment, the action of determining the starting position for reading, from the circular buffer, the data bits forming the data packet to be transmitted according to the transmission sequence corresponding to the data packet to be transmitted may include that: if the current data packet to be transmitted is the data packet to be transmitted for the nth time and column indexes of the circular buffer are [0, 1, 2, . . . , r·C_{subblock}−1], where r·C_{subblock} may denote the number of columns of the circular buffer, when n is an odd number, the starting position of the current data packet to be transmitted is determined to be a first significant bit of a first column of the circular buffer; and when n is an even number, the starting position of the current data packet to be transmitted is determined to be a first significant bit of a

$$B \cdot operation ( \frac{r \cdot {C}_{subblock}}{2 \cdot B} )$$

th column of the circular buffer, where B may be a constant positive integer, C_{subblock} denotes a number of columns of the sub-block interleaver, r is a number of the bit streams resulting from convolutional code coding, operation(•) denotes the rounding operation which may be rounding-up, rounding-down or rounding-off.

According to an embodiment, the action of determining the starting position for reading, from the circular buffer, the data bits forming the data packet to be transmitted may include the following actions. The starting position for reading, from the circular buffer, the data bits forming the data packet to be transmitted is determined to be the first significant bit of the circular buffer.

The disclosure provides a convolutional-code-based data sending device. The device includes a coding and caching module, a starting position determination module and a data reading and sending module. The coding and caching module is arranged to perform convolutional code coding on data bits of an input information block and arrange the coded data bits into a circular buffer. The starting position determination module is arranged to determine a starting position for reading, from the circular buffer, data bits forming a data packet to be transmitted. The data reading and sending module is arranged to read data bits of a specific length column by column from the starting position according to a sequence of the columns to form a data packet to be transmitted and send the data packet to be transmitted.

According to an embodiment, the coding and caching module may include a coder, sub-block interleavers and a rearrangement unit. The coder is arranged to perform convolutional code coding on the data bits of the input information block and output r check bit streams, where r may be an integer more than or equal to 2. The sub-block interleavers are arranged to receive the check bit streams output by the coder. The rearrangement unit is arranged to perform inter-column rearrangement on the check bit streams input into each sub-block interleaver according to a given rearrangement vector respectively.

According to an embodiment, the coding and caching module may include: a bit interleaving unit, arranged to perform bit interleaving on t rearranged check bit streams, where t may be a positive integer, and 2≤t≤r.

According to an embodiment, the starting position determination module may be arranged to: determine the starting position for reading, from the circular buffer, the data bits forming the data packet to be transmitted according to a redundancy version value corresponding to the data packet to be formed and transmitted; or, determine the starting position for reading, from the circular buffer, the data bits forming the data packet to be transmitted according to data packets which have been sent; or, determine the starting position for reading, from the circular buffer, the data bits forming the data packet to be transmitted according to a transmission sequence corresponding to the data packet to be transmitted.

According to an embodiment, that the starting position determination module is arranged to determine the starting position for reading, from the circular buffer, the data bits forming the data packet to be transmitted according to the redundancy version value corresponding to the data packet to be formed and transmitted may include that: when there are Nᵣᵥ redundancy version values corresponding to the data packet to be transmitted, the starting position is determined to be

$${k}_{0} = {R}_{subblock} \cdot [ A \cdot Operation ( \frac{{N}_{cb}}{{R}_{subblock} \cdot {N}_{rv} \cdot A} \cdot {rv}_{idx} ) ] ,$$

where R_{subblock} denotes a number of rows of the sub-block interleaver, N_{ch} denotes a size of the circular buffer, Nᵣᵥ may denote a number of the redundancy version values, Nᵣᵥ is a positive integer, rv_{idx} iv denotes the redundancy version value, rv_{idx} is valued from a set {0, 1, K Nᵣᵥ−1}, Operation(•) denotes a rounding operation which may be rounding-up, rounding-down or rounding-off, and A is a constant positive integer.

According to an embodiment, that the starting position determination module is arranged to determine the starting position for reading, from the circular buffer, the data bits forming the data packet to be transmitted according to the data packets which have been sent may include that: when the current data packet to be transmitted is a data packet to be transmitted for the nth time and a length of data packets which have been sent for the last n−1 times is Ei, the starting position of the data bits of the current data packet to be transmitted is determined to be k₀=R_{subblock}·mod(Cₙ₋₁,(r·C_{subblock})), where R_{subblock} denotes the number of rows of the sub-block interleaver, C_{subblock} denotes a number of columns of the sub-block interleaver, r is a number of the bit streams resulting from convolutional code coding, mod(•) denotes a remainder calculation operation, Cₙ₋₁ denotes a number of columns of the circular buffer corresponding to the data packets which have been sent for the last n−1 times,

$${C}_{n - 1} = {\sum }_{i = 1}^{n - 1} ⌈ \frac{{E}_{i}}{{R}_{subblock}} ⌉ , or , {C}_{n - 1} = {\sum }_{i = 1}^{n - 1} ⌈ \frac{{E}_{i}}{{R}_{subblock}} ⌉ - n + 1 ,$$

where n and i may be positive integers, 1≤i≤n−1, and ┌ ┐ denotes a rounding-up operation.

According to an embodiment, that the starting position determination module is arranged to determine the starting position for reading, from the circular buffer, the data bits forming the data packet to be transmitted according to the transmission sequence corresponding to the data packet to be transmitted may include that: when the current data packet to be transmitted is the data packet to be transmitted for the nth time, when n is an odd number, the starting position of the current data packet to be transmitted is determined to be a first significant bit of the circular buffer; and when n is an even number, the starting position of the current data packet to be transmitted is determined to be a first significant bit of a central column of the circular buffer, where n is a positive integer.

According to an embodiment, that the starting position determination module is arranged to determine the starting position for reading, from the circular buffer, the data bits forming the data packet to be transmitted according to the transmission sequence corresponding to the data packet to be transmitted may include that: when the current data packet to be transmitted is the data packet to be transmitted for the nth time and column indexes of the circular buffer are [0, 1, 2, . . . , r·C_{subblock}−1], where r·C_{subblock} denotes the number of columns of the circular buffer, when n is an odd number, the starting position of the current data packet to be transmitted is determined to be a first significant bit of a first column of the circular buffer; and when n is an even number, the starting position of the current data packet to be transmitted is determined to be a first significant bit of a

$$B \cdot operation ( \frac{r \cdot {C}_{subblock}}{2 \cdot B} )$$

th column of the circular buffer, where B is a constant positive integer, C_{subblock} denotes the number of columns of the sub-block interleaver, r is a number of the bit streams resulting from convolutional code coding, operation(•) denotes the rounding operation which may be rounding-up, rounding-down or rounding-off.

According to an embodiment, that the starting position determination module is arranged to determine the starting position for reading, from the circular buffer, the data bits forming the data packet to be transmitted may include that: the starting position for reading, from the circular buffer, the data bits forming the data packet to be transmitted is determined to be the first significant bit of the circular buffer.

Another embodiment of the disclosure provides a computer storage medium, which stores an executable instruction, the executable instruction being arranged to execute the method in an abovementioned embodiment.

In the disclosure, convolutional code coding is performed on the data bits of the input information block, and the coded data bits form the circular buffer. The starting position for reading, from the circular buffer, the data bits forming the data packet to be transmitted is determined. The data bits of the specific length are read column by column from the starting position according to the sequence of the columns to form the data packet to be transmitted. The data packet to be transmitted is sent. Therefore, according to the disclosure, a convolutional-code-based data packet to be transmitted with a flexible rate may be generated, and the problem of how to reasonably select a data packet to be transmitted each time to achieve a more flexible rate and higher performance after combination by a receiver in a conventional art is solved.

In the embodiments of the disclosure, convolutional code coding is performed on the data bits of the input information block, the r check bit streams are output, the r check bit streams are input into the sub-block interleavers with a same size respectively. Inter-column rearrangement is performed on the bit streams input into each sub-block interleaver respectively. The coded data bits form the circular buffer. The starting position for reading, from the circular buffer, the data bits forming the data packet to be transmitted is determined. The data bits of the specific length are read column by column from the starting position according to the sequence of the columns to form the data packet to be transmitted, and the data packet to be transmitted is sent. Therefore, according to the embodiments of the disclosure, a convolutional-code-based data packet to be transmitted with a flexible rate is generated on the basis of RM of the circular buffer, so that an optimal retransmission effect is achieved for convolutional-code-based data retransmission, and the embodiments are particularly applicable to a narrowband communication scenario compatible with an LTE technology.

### BRIEF DESCRIPTION OF DRAWINGS

FIG. 1 is a schematic diagram of an existing digital communication system.

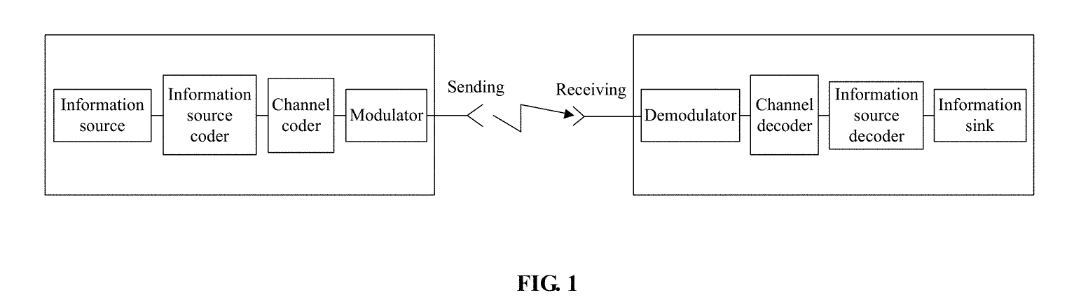

FIG. 2 is a structure diagram of a convolutional code coder adopted for an LTE system.

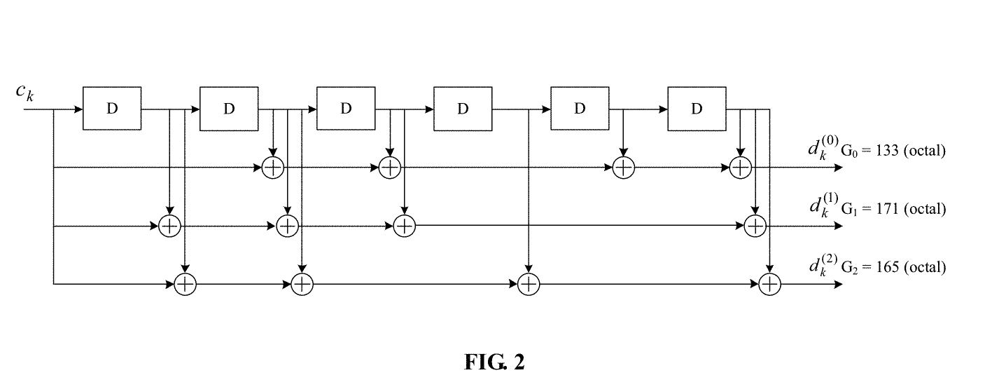

FIG. 3 is a flowchart of a convolutional-code-based data sending method according to an embodiment of the disclosure.

FIG. 4 is a schematic diagram of a determined starting position of a data packet to be transmitted according to embodiment 1 of the disclosure.

FIG. 5 is a schematic diagram of a determined starting position of a data packet to be transmitted according to embodiment 2 of the disclosure.

FIG. 6 is a schematic diagram of a determined starting position of a data packet to be transmitted according to embodiment 3 of the disclosure.

FIG. 7 is a schematic diagram of a determined starting position of a data packet to be transmitted according to embodiment 4 of the disclosure.

FIG. 8 is a schematic diagram of a convolutional-code-based data sending device according to an embodiment of the disclosure.

### DETAILED DESCRIPTION

The embodiments of the disclosure will be described below in combination with the drawings in detail. It should be understood that the embodiments described below are only adopted to describe and explain the disclosure and not intended to limit the invention.

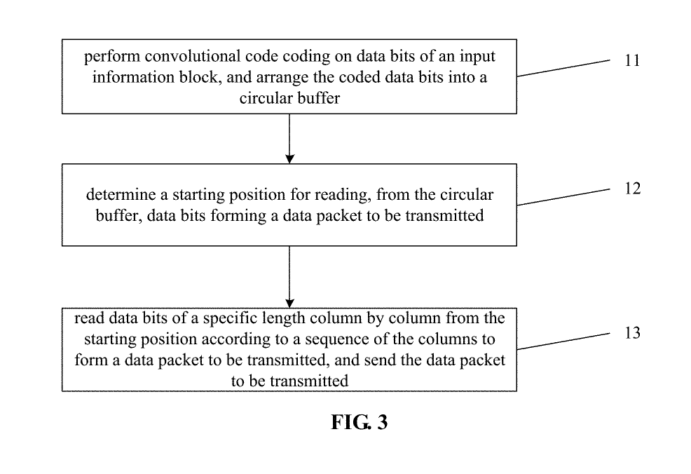

FIG. 3 is a flowchart of a convolutional-code-based data sending method according to an embodiment of the disclosure. As shown in FIG. 3, the convolutional-code-based data sending method provided by the embodiment of the disclosure includes the following steps.

In S11, convolutional code coding is performed on data bits of an input information block, and the coded data bits form a circular buffer.

Here, S11 includes that:

convolutional code coding is performed on the data bits of the input information block, and r check bit streams are output, where r is an integer more than or equal to 2;

the r check bit streams resulting from convolutional code coding are input into sub-block interleavers with the same size; and

inter-column rearrangement is performed on the check bit streams input into each sub-block interleaver according to a given rearrangement vector respectively.

Optionally, S11 further includes that: bit interleaving is performed on t rearranged check bit streams, where t is a positive integer, and where the action of performing bit interleaving on the t rearranged check bit streams includes that: the data bits in the t rearranged check bit streams are alternately arranged according to a sequence.

In S12, a starting position for reading, from the circular buffer, data bits forming a data packet to be transmitted is determined.

Here, S12 includes that:

the starting position for reading, from the circular buffer, the data bits forming the data packet to be transmitted is determined according to a redundancy version value corresponding to the data packet to be formed and transmitted; or, the starting position for reading, from the circular buffer, the data bits forming the data packet to be transmitted is determined according to data packets which have been sent; or,

the starting position for reading, from the circular buffer, the data bits forming the data packet to be transmitted is determined according to a transmission sequence corresponding to the data packet to be transmitted.

In an embodiment, the action of determining the starting position for reading, from the circular buffer, the data bits forming the data packet to be transmitted according to the redundancy version value corresponding to the data packet to be formed and transmitted includes that:

if there are Nᵣᵥ redundancy version values corresponding to the data packet to be transmitted, the starting position is determined to be

$${k}_{0} = {R}_{subblock} \cdot [ A \cdot Operation ( \frac{{N}_{cb}}{{R}_{subblock} \cdot {N}_{rv} \cdot A} \cdot {rv}_{idx} ) ] ,$$

where R_{subblock} denote a number of rows of the sub-block interleaver, N_{Cb} denotes a size of the circular buffer, Nᵣᵥ denotes a number of the redundancy version values, Nᵣᵥ is a positive integer, denotes the redundancy version value, rv_{idx} is valued from a set {0, 1, K Nᵣᵥ−1}, Operation(•) represents a rounding operation which is rounding-up, rounding-down or rounding-off, and A is a constant positive integer.

Where, a redundancy version value corresponding to a data packet transmitted for the first time is rv_{idx}=0.

Optionally, a redundancy version value corresponding to a data packet transmitted for the nth time is rv_{idx}=mod(n−1,Nᵣᵥ), where n is a positive integer, and mod(•) represents a remainder calculation operation.

In an embodiment, the action of determining the starting position for reading, from the circular buffer, the data bits forming the data packet to be transmitted according to the data packets which have been sent includes that:

if the current data packet to be transmitted is the data packet to be transmitted for the nth time and a length of data packets which have been sent for the last n−1 times is Ei, the starting position of the data bits of the current data packet to be transmitted is determined to be k₀=R_{subblock}·mod(Cₙ₋₁,(r·C_{subblock})),

where R_{subblock} denotes the number of rows of the sub-block interleaver, C_{subblock} denotes a number of columns of the sub-block interleaver, r is the number of the bit streams resulting from convolutional code coding, mod(•) represents the remainder calculation operation, Cₙ₋₁ denotes a number of columns of the circular buffer corresponding to the data packets which have been sent for the last n−1 times,

$${C}_{n = 1} = {\sum }_{i = 1}^{n - 1} ⌈ \frac{{E}_{i}}{{R}_{subblock}} ⌉ , or , {C}_{n - 1} = {\sum }_{i = 1}^{n - 1} ⌈ \frac{{E}_{i}}{{R}_{subblock}} ⌉ - n + 1 ,$$

where n and i are positive integers, 1≤i≤n−1, and ┌ ┐ represents a rounding-up operation.

Here, a starting position for reading data bits forming the data packet transmitted for the first time from the circular buffer is a first significant bit of the circular buffer.

In an embodiment, the action of determining the starting position for reading, from the circular buffer, the data bits forming the data packet to be transmitted according to the transmission sequence corresponding to the data packet to be transmitted includes that:

if the current data packet to be transmitted is the data packet to be transmitted for the nth time and if n is an odd number (that is, mod(n,2)=1), the starting position of the current data packet to be transmitted is determined to be a first significant bit of the circular buffer; and if n is an even number (that is, mod(n,2)=0), the starting position of the current data packet to be transmitted is determined to be a first significant bit of a central column of the circular buffer, where n is a positive integer, and mod(•) represents the remainder calculation operation.

In an embodiment, the action of determining the starting position for reading, from the circular buffer, the data bits forming the data packet to be transmitted according to the transmission sequence corresponding to the data packet to be transmitted includes that:

if the current data packet to be transmitted is the data packet to be transmitted for the nth time and column indexes of the circular buffer are [0, 1, 2, . . . , r·C_{subblock}−1], where r·C_{subblock} denotes the number of columns of the circular buffer, when n is an odd number, the starting position of the current data packet to be transmitted is determined to be a first significant bit of a first column of the circular buffer; and when n is an even number, the starting position of the current data packet to be transmitted is determined to be a first significant bit of a

$$B \cdot operation ( \frac{r \cdot {C}_{subblock}}{2 \cdot B} )$$

column of the circular buffer, where B is a constant positive integer, C_{subblock} denotes the number of the columns of the sub-block interleaver, r is the number of the bit streams resulting from convolutional code coding, operation(•) represents the rounding operation which is rounding-up, rounding-down or rounding-off.

In S13, data bits of a specific length are read column by column from the starting position according to a sequence of the columns to form a data packet to be transmitted, and the data packet to be transmitted is sent.

The disclosure will be described below with multiple specific embodiments.

### Embodiment 1

A convolutional-code-based data sending method provided by the embodiment includes the following steps.

In SA1, convolutional code coding is performed on data bits of an input information block,

where coding in SA1 is implemented with a convolutional code or tail-biting convolutional code with r coding branches, and each coding branch corresponds to a check bit stream, so that there are totally r output check bit streams.

In SA2, the coded data bits form a circular buffer.

Specifically, SA2 includes the following sub-steps: bit separation is performed on the data bits subjected to convolutional code coding, and a first check bit stream) dₖ⁽⁰⁾, a second check bit stream dₖ⁽¹⁾, . . . , an rth check bit stream dₖ^{(r)} are output, where r is an integer more than or equal to 2; the first check bit stream dₖ⁽⁰⁾, second check bit stream dₖ⁽¹⁾, . . . , rth check bit stream dₖ^{(r)} output by separation are input into three sub-block interleavers with a size of K_{π}=(R_{subblock}×C_{subblock}) respectively; the data bit streams input into the sub-block interleavers are subjected to inter-column rearrangement respectively, a rearrangement vector being a given known vector, and are read from each sub-block interleaver column by column from top to bottom according to a sequence of the columns respectively; and bit interleaving is performed on t bit streams, t being a positive integer and 2≤t≤r, where an interleaving method is to alternatively arrange the bits in the t bit streams according to a sequence, and particularly, when a number of the check bit streams resulting from convolutional code coding is r=3 and the second check bit stream and the third check bit stream are interleaved, the interleaving method is as follows: wₖ=Pₖ⁽¹⁾, w_{K}_{_{π}}₊₂ₖ=Pₖ⁽²⁾ and wₖ_{_{π}}₊₂ₖ₊₁=Pₖ⁽³⁾, where Pₖ⁽¹⁾, Pₖ⁽²⁾, and Pₖ⁽³⁾ are the data bits in the first, second and third rearranged check bit streams respectively, w_{K}_{_{π}}₊₂ₖ is the data bits of the second rearranged check bit stream subjected to bit interleaving, and w_{K}_{_{π}}₊₂ₖ₊₁ is the data bits of the third rearranged check bit stream subjected to bit interleaving, where k=0, . . . , K_{π}−1. It is important to point out that the bit interleaving method may not be limited to that.

Where, each sub-block interleaver follows a row-in column-out principle, its number of columns C_{subblock} is a specific constant, and its number of rows R_{subblock} is determined by D≤(R_{subblock}×C_{subblock}), where D is a length of the check bit stream; if (R_{subblock}×C_{subblock})>D, it is necessary to add N_{D} “virtual bits” to each data bit stream, where N_{D}=(R_{subblock}×C_{subblock}−D), and positions for addition of the virtual bits may be, but not limited to, the forefront of each data bit stream.

It is important to note that: for simplifying hardware implementation, the number of columns of the sub-block interleavers is fixed and the number of rows are changed along with changing of an interleaving length, so that the circular buffer may be considered as an “R row×C column” row-column buffer, where a number of columns C of the circular buffer is equal to a sum of the numbers of columns of sub-block interleavers, that is, C=r·C_{subblock}, where C_{subblock} denotes the number of columns of the sub-block interleaver, and r is the number of the check bit streams output by coding. In addition, the circular buffer may have no real physical entity but is implemented by a logical addressing operation, and thus may also be considered as an “R row×C column” virtual buffer. For any expected rate, bit selection for RM of the circular buffer is to sequentially read a bit stream of a required length from a certain starting point of the buffer as output of RM.

In SA3, a starting position k0 for reading, from the circular buffer, data bits of a current data packet to be transmitted is determined according to a redundancy version value corresponding to the data packet to be formed and transmitted.

Considering convenience of hardware implementation, bits selected for transmission are preferably read from a starting position of a certain column of the virtual buffer, rather than any bit position.

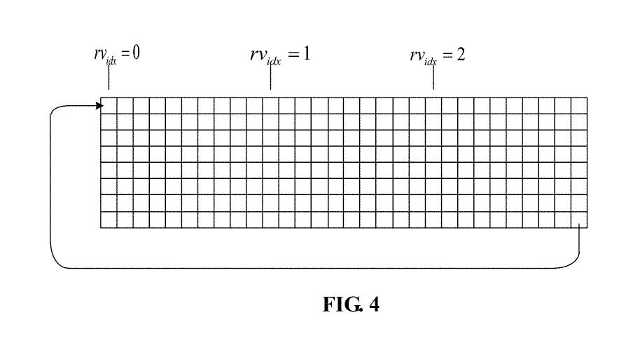

Specifically, if there are Nᵣᵥ redundancy version values corresponding to the data packet to be transmitted, where Nᵣᵥ is a positive integer, the starting position is determined to be

$${k}_{0} = {R}_{subblock} \cdot [ A \cdot Operation ( \frac{{N}_{cb}}{{R}_{subblock} \cdot {N}_{rv} \cdot A} \cdot {rv}_{idx} ) ] ,$$

where R_{subblock} denotes the number of rows of the sub-block interleaver, N_{cb} is a size of the convolutional code circular buffer, Nᵣᵥ represents a number of the redundancy version values, rv_{idx} represents the redundancy version value, rv_{idx} is valued from a set {0, 1, K Nᵣᵥ−1}, Operation(•) represents a rounding operation which is rounding-up, rounding-down or rounding-off, and A is a constant positive integer.

Where, when Nᵣᵥ=3, the position of the data packet to be transmitted in the circular buffer is shown in FIG. 4.

In SA4, data bits of a specific length are read column by column from the starting position according to a sequence of the columns to form the current data packet to be transmitted.

Specifically, L data bits (L is a size of the current data packet to be transmitted) are read column by column from a starting position corresponding to a present redundancy version value in a limited-length data buffer to form the current data packet to be transmitted, and if a “virtual bit” is met in a bit reading process, it is skipped and not read until L significant bits are read; and according to a characteristic of the circular buffer, if the tail of the circular buffer is reached, data may be continued to be read from an initial position of the circular buffer, where a data packet transmitted for the first time is read from a first significant bit of the circular buffer, and a redundancy version value corresponding to the data packet transmitted for the first time is rv_{idx}=0; and a redundancy version value corresponding to a data packet transmitted for the nth time is rv_{idx}=mod(n−1,Nᵣᵥ), where n is a positive integer, and mod(•) represents a remainder calculation operation.

In SA5, the current data packet to be transmitted is sent to a subsequent processing module.

### Embodiment 2

A convolutional-code-based data sending method provided by the embodiment includes the following steps.

In SB1, convolutional code coding is performed on data bits of an input information block,

where coding in SB1 is implemented with a convolutional code or tail-biting convolutional code with r coding branches, and each coding branch corresponds to a check bit stream, so that there are totally r output check bit streams.

In SB2, the coded data bits form a circular buffer.

Specifically, SB2 includes the following sub-steps: bit separation is performed on the data bits subjected to convolutional code coding, and a first check bit stream) dₖ⁽⁰⁾, a second check bit stream dₖ⁽¹⁾, . . . , an rth check bit stream dₖ^{(r)} are output, where) r is an integer more than or equal to 2; the first check bit stream dₖ⁽⁰⁾, second check bit stream dₖ⁽¹⁾, . . . , rth check bit stream dₖ^{(r)} output by separation are input into three sub-block interleavers with a size of K_{π}=(R_{subblock}×C_{subblock}) respectively; the data bit streams input into the sub-block interleavers are subjected to inter-column rearrangement respectively, a rearrangement vector being a given known vector, and are read from each sub-block interleaver column by column from top to bottom according to a sequence of the columns respectively; and bit interleaving is performed on t bit streams, t being a positive integer and 2≤t≤r, where an interleaving method is to alternatively arrange the bits in the t bit streams according to a sequence, and particularly, when a number of the check bit streams resulting from convolutional code coding is r=3 and the second check bit stream and the third check bit stream are interleaved, the interleaving method is as follows: wₖ=Pₖ⁽¹⁾, w_{K}_{_{π}}₊₂ₖ=Pₖ⁽²⁾ and w_{K}_{_{π}}₊₂ₖ₊₁=Pₖ⁽³⁾, where Pₖ⁽¹⁾, Pₖ⁽²⁾ and Pₖ⁽³⁾ are the data bits in the first, second and third rearranged check bit streams respectively, w_{K}_{_{π}}₊₂ₖ is the data bits of the second rearranged check bit stream subjected to bit interleaving, and w_{K}_{_{π}}₊₂ₖ₊₁ is the data bits of the third rearranged check bit stream subjected to bit interleaving, where k=0, . . . , K_{π}−1. It is important to point out that the bit interleaving method may not be limited to that.

Where, each sub-block interleaver follows a row-in column-out principle, its number of columns C_{subblock} is a specific constant, and its number of rows R_{subblock} is determined by D≤(R_{subblock}×C_{subblock}), where D is a length of the check bit stream; if (R_{subblock}×C_{subblock})>D, it is necessary to add N_{D} “virtual bits” to each data bit stream, where N_{D}=(R_{subblock}×C_{subblock}−D), and positions for addition of the virtual bits may be, but not limited to, the forefront of each data bit stream.

It is important to note that: for simplifying hardware implementation, the number of columns of the sub-block interleavers is fixed and the number of rows is changed along with changing of an interleaving length, so that the circular buffer may be considered as an “R row×C column” row-column buffer, where a number of columns C of the circular buffer is equal to a sum of the numbers of columns of the sub-block interleavers, that is, C=r·C_{subblock}, where C_{subblock} denotes the number of columns the sub-block interleaver, and r is the number of the check bit streams resulting from coding. In addition, the circular buffer may have no real physical entity but is implemented by a logical addressing operation, and thus may also be considered as an “R row×C column” virtual buffer. For any expected rate, bit selection for RM of the circular buffer is to sequentially read a bit stream of a required length from a certain starting point of the buffer as output of RM.

In SB3, a starting position k0 for reading, from the circular buffer, data bits forming a data packet to be transmitted is determined according to data packets which have been sent.

In SB3, codeword bits selected for the data packet to be transmitted follow the data packets which have been sent before. Considering convenience of hardware implementation, bits selected for transmission are preferably read from a starting position of a certain column of the virtual buffer, rather than any bit position.

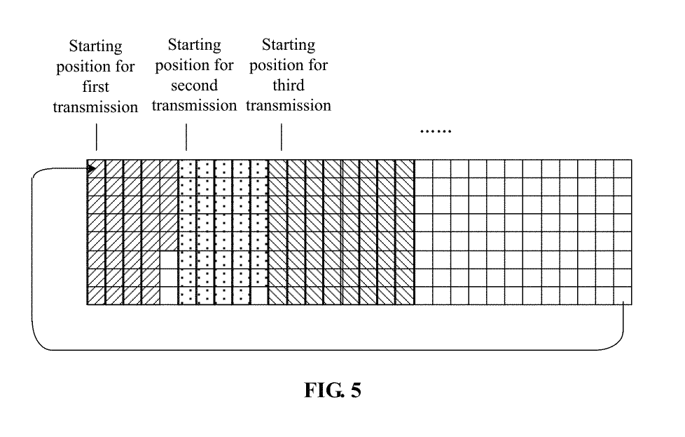

Specifically, since the circular buffer may also be considered as an “R_{subblock}×(r·C_{subblock})” “virtual circular buffer”, and for example, may be considered as a 3*32 column virtual buffer, if the data packets which have been transmitted before are ended at an ith column, even though this column has yet not been completely transmitted, codeword bits are read from an (i+1)th column for the current data packet to be transmitted, and if the tail of the buffer is reached, data is continued to be read from an initial position of the buffer until the required bits are completely read, as shown in FIG. 5.

If the current data packet to be transmitted is a data packet to be transmitted for the nth time and a length of data packets which have been sent for the last n−1 times is Ei, the starting position of the data bits of the current data packet to be transmitted is determined to be k₀=R_{subblock}·mod(Cₙ₋₁,(r·C_{subblock})),

where R_{subblock} denotes the number of rows of the sub-block interleaver, C_{subblock} is a number of columns of the sub-block interleaver, r is the number of the bit streams resulting from convolutional code coding, mod(•) denotes a remainder calculation operation, Cₙ₋₁ denotes a number of columns of the circular buffer corresponding to the data packets which have been sent for the last n−1 times,

$${C}_{n = 1} = {\sum }_{i = 1}^{n - 1} ⌈ \frac{{E}_{i}}{{R}_{subblock}} ⌉ , or , {C}_{n - 1} = {\sum }_{i = 1}^{n - 1} ⌈ \frac{{E}_{i}}{{R}_{subblock}} ⌉ - n + 1 ,$$

where n and i are positive integers, and 1≤i≤n−1, where ┌ ┐ represents a rounding-up operation.

In SB4, data bits of a specific length are read column by column from the starting position according to a sequence of the columns to form the current data packet to be transmitted.

Specifically, SB4 includes that: L data bits (L is a size of the current data packet to be transmitted) are read column by column from the starting position corresponding to the current data packet to be transmitted in a limited-length data buffer to form the current data packet to be transmitted, and if a “virtual bit” is met in a bit reading process, it is skipped and not read until L significant bits are read; and according to a characteristic of the circular buffer, if the tail of the circular buffer is reached, data may be continued to be read from an initial position of the circular buffer, where a data packet transmitted for the first time is read from a first significant bit of the circular buffer.

In SB5, the current data packet to be transmitted is sent to a subsequent processing module.

### Embodiment 3

A convolutional-code-based data sending method provided by the embodiment includes the following steps.

In SC1, convolutional code coding is performed on data bits of an input information block,

where coding in SC1 is implemented with a convolutional code or tail-biting convolutional code with r coding branches, and each coding branch corresponds to a check bit stream, so that there are totally r output check bit streams.

In SC2, the coded data bits form a circular buffer.

Specifically, SC2 includes the following sub-steps: bit separation is performed on the data bits subjected to convolutional code coding, and a first check bit stream dₖ⁽⁰⁾, a second check bit stream dₖ⁽¹⁾, . . . , an rth check bit stream dₖ^{(r)} are output, where r is an integer more than or equal to 2; the first check bit stream dₖ⁽⁰⁾, second check bit stream dₖ⁽¹⁾, . . . , rth check bit stream dₖ^{(r)} output by separation are input into three sub-block interleavers with a size of K_{π}=(R_{subblock}×C_{subblock}) respectively; the data bit streams input into the sub-block interleavers are subjected to inter-column rearrangement respectively, a rearrangement vector being a given known vector, and are read from each sub-block interleaver column by column from top to bottom according to a sequence of the columns respectively; and bit interleaving is performed on t bit streams, t being a positive integer and 2≤t≤r, where an interleaving method is to alternatively arrange the bits in the t bit streams according to a sequence, and particularly, when a number of the check bit streams resulting from convolutional code coding is r=3 and the second check bit stream and the third check bit stream are interleaved, the interleaving method is as follows: wₖ=Pₖ⁽¹⁾, w_{K}_{_{π}}₊₂ₖ=Pₖ⁽²⁾ and w_{K}_{_{π}}₊₂ₖ₊₁=Pₖ⁽³⁾, where Pₖ⁽¹⁾, Pₖ⁽²⁾ and Pₖ⁽³⁾ are the data bits in the first, second and third rearranged check bit streams respectively, w_{K}_{_{π}}₊₂ₖ is the data bits of the second rearranged check bit stream subjected to bit interleaving, and w_{K}_{_{π}}₊₂ₖ₊₁ is the data bits of the third rearranged check bit stream subjected to bit interleaving, where k=0, . . . , K_{π}−1. It is important to point out that the bit interleaving method may not be limited to that.

Where, each sub-block interleaver follows a row-in column-out principle, its number of columns C_{subblock} is a specific constant, and its number of rows R_{subblock} is determined by D≤(R_{subblock}×C_{subblock}), where D is a length of the check bit stream; if (R_{subblock}×C_{subblock})>D, it is necessary to add N_{D} “virtual bits” to each data bit stream, where N_{D}=(R_{subblock}×C_{subblock}−D), and positions for addition of the virtual bits may be, but not limited to, the forefront of each data bit stream.

It is important to note that: for simplifying hardware implementation, the number of columns of the sub-block interleavers is fixed and the number of rows is changed along with changing of an interleaving length, so that the circular buffer may be considered as an “R row×C column” row-column buffer, where a number of columns C of the circular buffer is equal to a sum of the numbers of columns of the sub-block interleavers, that is, C=r·C_{subblock}, where C_{subblock} denotes the number of columns of the sub-block interleaver, and r is the number of the check bit streams resulting from coding. In addition, the circular buffer may have no real physical entity but is implemented by a logical addressing operation, and thus may also be considered as an “R row×C column” virtual buffer. For any expected rate, bit selection for RM of the circular buffer is to sequentially read a bit stream of a required length from a certain starting point of the buffer as output of RM.

In SC3, a starting position k0 for reading, from the circular buffer, data bits forming a data packet to be transmitted is determined according to data packets which have been sent.

In SC3, codeword bits selected for the data packet to be transmitted follow a data packet which has been sent before, and are slightly overlapped with the data packet which has been sent last time. Considering convenience of hardware implementation, bits selected for transmission are preferably read from a starting position of a certain column of the virtual buffer, rather than any bit position.

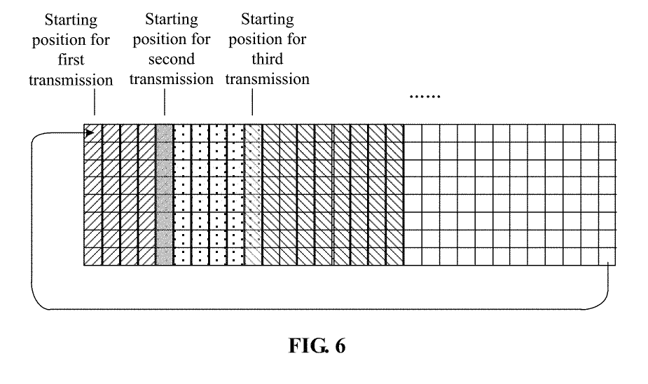

Specifically, since the circular buffer may also be considered as an “R_{subblock}×(r·C_{subblock})” “virtual circular buffer”, and for example, may be considered as a 3*32 column virtual buffer, if the data packets which have been transmitted before are ended at an ith column, even though this column has yet not been completely transmitted, codeword bits are read from an (i+1)th column for the current data packet to be transmitted, and if the tail of the buffer is reached, data is continued to be read from an initial position of the buffer until the required bits are completely read, as shown in FIG. 6.

If the current data packet to be transmitted is a data packet to be transmitted for the nth time and a length of data packets which have been sent for the last n−1 times is Ei, the starting position of the data bits of the current data packet to be transmitted is determined to be k₀=R_{subblock}·mod(Cₙ₋₁,(r·C_{subblock})),

where R_{subblock} denotes the number of rows of the sub-block interleaver, C_{subblock} is a number of columns of the sub-block interleaver, r is the number of the bit streams resulting from convolutional code coding, mod(•) represents a remainder calculation operation, Cₙ₋₁ denotes a number of columns of the circular buffer corresponding to the data packets which have been sent for the last n−1 times,

$${C}_{n = 1} = {\sum }_{i = 1}^{n - 1} ⌈ \frac{{E}_{i}}{{R}_{subblock}} ⌉ ,$$

where n and i are positive integers, 1≤i≤n−1, and ┌ ┐ represents a rounding-up operation.

In SC4, data bits of a specific length are read column by column from the starting position according to a sequence of the columns to form the current data packet to be transmitted.

Specifically, SC4 includes that: L data bits (L is a size of the current data packet to be transmitted) are read column by column from the starting position corresponding to the current data packet to be transmitted in a limited-length data buffer to form the current data packet to be transmitted, and if a “virtual bit” is met in a bit reading process, it is skipped and not read until L significant bits are read; and according to a characteristic of the circular buffer, if the tail of the circular buffer is reached, data may be continued to be read from an initial position of the circular buffer, where a data packet transmitted for the first time is read from a first significant bit of the circular buffer.

In SC5, the current data packet to be transmitted is sent to a subsequent processing module.

### Embodiment 4

A convolutional-code-based data sending method provided by the embodiment includes the following steps.

In SD1, convolutional code coding is performed on data bits of an input information block,

where coding in SD1 is implemented with a convolutional code or tail-biting convolutional code with r coding branches, and each coding branch corresponds to a check bit stream, so that there are totally r output check bit streams.

In SD2, the coded data bits form a circular buffer.

Specifically, SD2 includes the following sub-steps: bit separation is performed on the data bits subjected to convolutional code coding, and a first check bit stream dₖ⁽⁰⁾, a second check bit stream dₖ⁽¹⁾, . . . , an rth check bit stream dₖ^{(r)} are output, where r is an integer more than or equal to 2; the first check bit stream dₖ⁽⁰⁾, second check bit stream dₖ⁽¹⁾, . . . , rth check bit stream dₖ^{(r)} output by separation are input into three sub-block interleavers with a size of K_{π}=(R_{subblock}×C_{subblock}) respectively; the data bit streams input into the sub-block interleavers are subjected to inter-column rearrangement respectively, a rearrangement vector being a given known vector, and are read from each sub-block interleaver column by column from top to bottom according to a sequence of the columns respectively; and bit interleaving is performed on t bit streams, t being a positive integer and 2≤t≤r, where an interleaving method is to alternatively arrange the bits in the t bit streams according to a sequence, and particularly, when a number of the check bit streams resulting from convolutional code coding is r=3 and the second check bit stream and the third check bit stream are interleaved, the interleaving method is as follows: wₖ=Pₖ⁽¹⁾, w_{K}_{_{π}}₊₂ₖ=Pₖ⁽²⁾ and w_{K}_{_{π}}₊₂ₖ₊₁=Pₖ⁽³⁾, where Pₖ⁽¹⁾, Pₖ⁽²⁾ and Pₖ⁽³⁾ are the data bits in the first, second and third rearranged check bit streams respectively, W_{K}_{_{π}}₊₂ₖ is the data bits of the second rearranged check bit stream subjected to bit interleaving, and W_{K}_{_{π}}₊₂ₖ₊₁ is the data bits of the third rearranged check bit stream subjected to bit interleaving, where k=0, . . . , K_{π}−1. It is important to point out that the bit interleaving method may not be limited to that.

Where, each sub-block interleaver follows a row-in column-out principle, its number of columns C_{subblock} is a specific constant, and its number of rows R_{subblock} is determined by D≤(R_{subblock}×C_{subblock}), where D is a length of the check bit stream; if (R_{subblock}×C_{subblock})>D, it is necessary to add N_{D} “virtual bits” to each data bit stream, where N_{D}=(R_{subblock}×C_{subblock}−D), and positions for addition of the virtual bits may be, but not limited to, the forefront of each data bit stream.

It is important to note that: for simplifying hardware implementation, the number of columns of the sub-block interleavers is fixed and the number of rows is changed along with changing of an interleaving length, so that the circular buffer may be considered as an “R row×C column” row-column buffer, where a number of columns C of the circular buffer is equal to a sum of the numbers of columns of the sub-block interleavers, that is, C=r·C_{subblock}, where C_{subblock} denotes the number of columns of the sub-block interleaver, and r is the number of the check bit streams output by coding. In addition, the circular buffer may have no real physical entity but is implemented by a logical addressing operation, and thus may also be considered as an “R row×C column” virtual buffer. For any expected rate, bit selection for RM of the circular buffer is to sequentially read a bit stream of a required length from a certain starting point of the buffer as output of RM.

In SD3, a starting position for reading, from the circular buffer, data bits of a current data packet to be transmitted is determined according to a transmission sequence of the current data packet to be transmitted.

In SD3, considering convenience of hardware implementation, bits selected for transmission are preferably read from a starting position of a certain column of the virtual buffer, rather than any bit position.

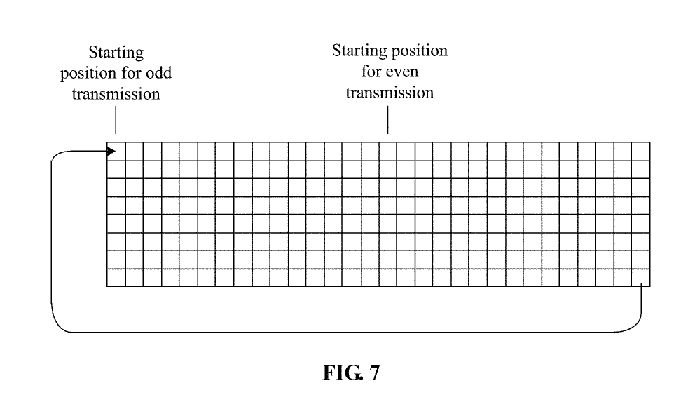

Specifically, since the circular buffer may also be considered as an “R_{subblock}×(r·C_{subblock})” “virtual circular buffer”, if the tail of the buffer is reached, data is continued to be read from an initial position of the buffer until the required bits are completely read, as shown in FIG. 7.

If the current data packet to be transmitted is a data packet to be transmitted for the nth time and if n is an odd number (that is, mod(n,2)=1), the starting position of the current data packet to be transmitted is determined to be a first significant bit of a first column of the circular buffer; and if n is an even number (that is, mod(n,2)=0), the starting position of the current data packet to be transmitted is a first significant bit of a central column of the circular buffer, where n is a positive integer, and mod(•) represents a remainder calculation operation.

Where, if the current data packet to be transmitted is the data packet to be transmitted for the nth time and column indexes of the circular buffer are [0, 1, 2, . . . , r·C_{subblock}−1], r·C_{subblock}, where subblock represents a number of columns of the circular buffer, when n is an odd number, the starting position of the current data packet to be transmitted is determined to be the first significant bit of the first column of the circular buffer; and when n is an even number, the starting position of the current data packet to be transmitted is determined to be a first significant bit of a

$$B \cdot operation ( \frac{r \cdot {C}_{subblock}}{2 \cdot B} ) th$$

column of the circular buffer, where B is a constant positive integer, C_{subblock} denotes the number of columns of the sub-block interleaver, r is a number of the bit streams resulting from convolutional code coding, operation(•) represents a rounding operation which is rounding-up, rounding-down or rounding-off.

In SD4, data bits of a specific length are read column by column from the starting position according to a sequence of the columns to form the current data packet to be transmitted.

Specifically, SD4 includes that: L data bits (L is a size of the current data packet to be transmitted) are read column by column from the starting position corresponding to the current data packet to be transmitted in a limited-length data buffer to form the current data packet to be transmitted, and if a “virtual bit” is met in a bit reading process, it is skipped and not read until L significant bits are read; and according to a characteristic of the circular buffer, if the tail of the circular buffer is reached, data may be continued to be read from an initial position of the circular buffer, where a data packet transmitted for the first time is read from a first significant bit of the circular buffer.

In SD5, the current data packet to be transmitted is sent to a subsequent processing module.

In addition, the embodiments of the disclosure further provide a convolutional-code-based data sending device, which includes: a coding and caching module, arranged to perform convolutional code coding on data bits of an input information block and arrange the coded data bits into a circular buffer; a starting position determination module, arranged to determine a starting position for reading, from the circular buffer, data bits forming a data packet to be transmitted; and a data reading and sending module, arranged to read data bits of a specific length column by column from the starting position according to a sequence of the columns to form the data packet to be transmitted and send the data packet to be transmitted.

Optionally, the coding and caching module includes:

a coder, arranged to perform convolutional code coding on the data bits of the input information block and output r check bit streams, where r is an integer more than or equal to 2;

sub-block interleavers, arranged to receive the check bit streams output by the coder; and

a rearrangement unit, arranged to perform inter-column rearrangement on the check bit streams input into each sub-block interleaver according to a given rearrangement vector respectively.

Optionally, the coding and caching module further includes: a bit interleaving unit, arranged to perform bit interleaving on t rearranged check bit streams, where t is a positive integer, and 2≤t≤r.

Optionally, the starting position determination module is specifically arranged to:

determine the starting position for reading, from the circular buffer, the data bits forming the data packet to be transmitted according to a redundancy version value corresponding to the data packet to be formed and transmitted; or,

determine the starting position for reading, from the circular buffer, the data bits forming the data packet to be transmitted according to data packets which have been sent; or,

determine the starting position for reading, from the circular buffer, the data bits forming the data packet to be transmitted according to a transmission sequence corresponding to the data packet to be transmitted.

In an embodiment, that the starting position determination module is arranged to determine the starting position for reading, from the circular buffer, the data bits forming the data packet to be transmitted according to the redundancy version value corresponding to the data packet to be formed and transmitted includes that:

if there are Nᵣᵥ redundancy version values corresponding to the data packet to be transmitted, the starting position is determined to be

$${k}_{0} = {R}_{subblock} \cdot [ A \cdot Operation ( \frac{{N}_{cb}}{{R}_{subblock} \cdot {N}_{rv} \cdot A} \cdot {rv}_{idx} ) ] ,$$

where R_{subblock} denotes a number of rows of the sub-block interleaver, N_{cb} denotes a size of the circular buffer, Nᵣᵥ denotes a number of the redundancy version values, Nᵣᵥ is a positive integer, denotes the redundancy version value, rv_{idx} is valued from a set {0, 1, K Nᵣᵥ−1}, Operation(•) represents a rounding operation which is rounding-up, rounding-down or rounding-off, and A is a constant positive integer.

In an embodiment, that the starting position determination module is arranged to determine the starting position for reading, from the circular buffer, the data bits forming the data packet to be transmitted according to the data packets which have been sent includes that:

if the current data packet to be transmitted is a data packet to be transmitted for the nth time and a length of data packets which have been sent for the last n−1 times is Ei, the starting position of the data bits of the current data packet to be transmitted is determined to be k₀=R_{subblock}·mod(Cₙ₋₁,(r·C_{subblock})),

where R_{subblock} denotes the number of rows of the sub-block interleaver, C_{subblock} denotes a number of columns of the sub-block interleaver, r is the number of the bit streams resulting from convolutional code coding, mod(•) denotes a remainder calculation operation, Cₙ₋₁ represents a number of columns of the circular buffer corresponding to the data packets which have been sent for the last n−1 times,

$${C}_{n = 1} = {\sum }_{i = 1}^{n - 1} ⌈ \frac{{E}_{i}}{{R}_{subblock}} ⌉ , or , {C}_{n - 1} = {\sum }_{i = 1}^{n - 1} ⌈ \frac{{E}_{i}}{{R}_{subblock}} ⌉ - n + 1 ,$$

where n and i are positive integers, 1≤i≤n−1, and ┌ ┐ represents a rounding-up operation.

In an embodiment, that the starting position determination module is arranged to determine the starting position for reading, from the circular buffer, the data bits forming the data packet to be transmitted according to the transmission sequence corresponding to the data packet to be transmitted includes that:

if the current data packet to be transmitted is the data packet to be transmitted for the nth time and if n is an odd number, the starting position of the current data packet to be transmitted is determined to be a first significant bit of the circular buffer; and if n is an even number, the starting position of the current data packet to be transmitted is determined to be a first significant bit of a central column of the circular buffer, where n is a positive integer.

In an embodiment, that the starting position determination module is arranged to determine the starting position for reading, from the circular buffer, the data bits forming the data packet to be transmitted according to the transmission sequence corresponding to the data packet to be transmitted includes that:

if the current data packet to be transmitted is the data packet to be transmitted for the nth time and column indexes of the circular buffer are [0, 1, 2, . . . , r·C_{subblock}−1], where r·C_{subblock} denotes the number of columns of the circular buffer, when n is an odd number, the starting position of the current data packet to be transmitted is determined to be a first significant bit of a first column of the circular buffer; and when n is an even number, the starting position of the current data packet to be transmitted is determined to be a first significant bit of a

$$B \cdot operation ( \frac{r \cdot {C}_{subblock}}{2 \cdot B} ) th$$

column of the circular buffer, where B is a constant positive integer, C_{subblock} is the number of columns of the sub-block interleaver, r is the number of the bit streams resulting from convolutional code coding, operation(•) represents the rounding operation which is rounding-up, rounding-down or rounding-off.

Furthermore, the starting position determination module is arranged to determine the starting position for reading, from the circular buffer, the data bits forming the data packet to be transmitted to be the first significant bit of the circular buffer.

A specific processing flow of the device is the same as the method, and thus will not be elaborated herein.

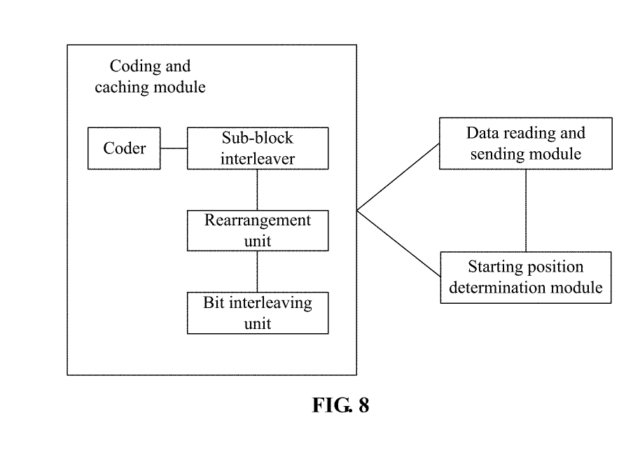

FIG. 8 is a schematic diagram of a convolutional-code-based data sending device according to an embodiment of the disclosure. As shown in FIG. 8, the convolutional-code-based data sending device provided by the embodiment includes a coding and caching module, a starting position determination module and a data reading and sending module, where the coding and caching module includes a coder, sub-block interleavers, a rearrangement unit and a bit interleaving unit. A specific processing flow of each module/unit is the same as those mentioned above, and thus will not be elaborated herein. During a practical application, each module/unit may be implemented by executing a program/instruction stored in a memory by a processor, which is not limited by the disclosure. Functions of these modules/units may further be realized by firmware/logical circuits/integrated circuits.

A basic principle and main characteristics of the disclosure and advantages of the disclosure are displayed and described above. The disclosure is not limited to the abovementioned embodiments, only the principle illustrating the disclosure is described in the abovementioned embodiments and the specification, various variations and improvements may further be made to the disclosure without departing from the spirit and scope of the disclosure, and these variations and improvements all fall within the scope of the disclosure required to be protected.

### INDUSTRIAL APPLICABILITY

As mentioned above, the convolutional-code-based data sending method and device provided by the embodiments of the disclosure have the following beneficial effects: a convolutional-code-based data packet to be transmitted with a flexible rate may be generated, and the problem of how to reasonably select a data packet to be transmitted each time to achieve a more flexible rate and higher performance after combination by a receiver in a conventional art is solved.

1. A convolutional-code-based data sending method, comprising:
performing convolutional code coding on data bits of an input information block, and arranging the coded data bits into a circular buffer;
determining a starting position for reading, from the circular buffer, data bits forming a data packet to be transmitted; and
reading data bits of a specific length column by column from the starting position according to a sequence of the columns to form a data packet to be transmitted, and sending the data packet to be transmitted.

2. The method according to claim 1, wherein performing convolutional code coding on the data bits of the input information block and arranging the coded data bits into the circular buffer comprises:
performing convolutional code coding on the data bits of the input information block, and outputting r check bit streams, wherein r is an integer more than or equal to 2;
inputting the r check bit streams resulting from convolutional code coding into sub-block interleavers with a same size; and
performing inter-column rearrangement on the check bit streams input into each sub-block interleaver according to a given rearrangement vector respectively.

3. The method according to claim 2, wherein after performing inter-column rearrangement on the check bit streams input into each sub-block interleaver according to the given rearrangement vector respectively, the method comprises: performing bit interleaving on t rearranged check bit streams, wherein t is a positive integer, and 2≤t≤r.

4. The method according to claim 1, wherein determining the starting position for reading, from the circular buffer, the data bits forming the data packet to be transmitted comprises:
according to a redundancy version value corresponding to the data packet to be formed and transmitted, determining the starting position for reading, from the circular buffer, the data bits forming the data packet to be transmitted; or,
according to data packets which have been sent, determining the starting position for reading, from the circular buffer, the data bits forming the data packet to be transmitted; or,
according to a transmission sequence corresponding to the data packet to be transmitted, determining the starting position for reading, from the circular buffer, the data bits forming the data packet to be transmitted.

5. The method according to claim 4, wherein determining the starting position for reading, from the circular buffer, the data bits forming the data packet to be transmitted according to the redundancy version value corresponding to the data packet to be formed and transmitted comprises:
when there are Nᵣᵥ redundancy version values corresponding to the data packet to be transmitted, determining the starting position to be
$${k}_{0} = {R}_{subblock} \cdot [ A \cdot Operation ( \frac{{N}_{cb}}{{R}_{subblock} \cdot {N}_{rv} \cdot A} \cdot {rv}_{idx} ) ] ,$$
wherein R_{subblock} denotes a number of rows of the sub-block interleaver, N_{cb} denotes a size of the circular buffer, Nᵣᵥ denotes a number of the redundancy version values, Nᵣᵥ is a positive integer, rv_{idx} denotes the redundancy version value, rv_{idx} is valued from a set {0, 1, K Nᵣᵥ−1}, Operation(•) represents a rounding operation which is rounding-up, rounding-down or rounding-off, and A is a constant positive integer.

6. The method according to claim 5, wherein a redundancy version value corresponding to a data packet transmitted for the first time is rv_{idx}=0.

7. The method according to claim 4, wherein determining the starting position for reading, from the circular buffer, the data bits forming the data packet to be transmitted according to the data packets which have been sent comprises:
when the current data packet to be transmitted is a data packet to be transmitted for the nth time and a length of data packets which have been sent for the last n−1 times is Ei, determining the starting position of the data bits of the current data packet to be transmitted to be k₀=R_{subblock}·mod(Cₙ₋₁,(r·C_{subblock})),
wherein R_{subblock} denotes a number of rows of the sub-block interleaver, C_{subblock} denotes a number of columns of the sub-block interleaver, r is a number of the bit streams resulting from convolutional code coding, mod(•) denotes a remainder calculation operation, Cₙ₋₁ denotes a number of columns of the circular buffer corresponding to the data packets which have been sent for the last n−1 times,
$${C}_{n = 1} = {\sum }_{i = 1}^{n - 1} ⌈ \frac{{E}_{i}}{{R}_{subblock}} ⌉ , or , {C}_{n - 1} = {\sum }_{i = 1}^{n - 1} ⌈ \frac{{E}_{i}}{{R}_{subblock}} ⌉ - n + 1 ,$$
wherein n and i are positive integers, 1≤i≤n−1, and ┌ ┐ denotes a rounding-up operation.

8. The method according to claim 4, wherein determining the starting position for reading, from the circular buffer, the data bits forming the data packet to be transmitted according to the transmission sequence corresponding to the data packet to be transmitted comprises:
when the current data packet to be transmitted is the data packet to be transmitted for the nth time and when n is an odd number, determining the starting position of the current data packet to be transmitted to be a first significant bit of the circular buffer; and when n is an even number, determining the starting position of the current data packet to be transmitted to be a first significant bit of a central column of the circular buffer, wherein n is a positive integer.

9. The method according to claim 4, wherein determining the starting position for reading, from the circular buffer, the data bits forming the data packet to be transmitted according to the transmission sequence corresponding to the data packet to be transmitted comprises:
when the current data packet to be transmitted is the data packet to be transmitted for the nth time and column indexes of the circular buffer are [0, 1, 2, . . . , r·C_{subblock}−1], wherein r·C_{subblock} denotes the number of columns of the circular buffer, when n is an odd number, determining the starting position of the current data packet to be transmitted to be a first significant bit of a first column of the circular buffer; and when n is an even number, determining the starting position of the current data packet to be transmitted to be a first significant bit of a
$$B \cdot operation ( \frac{r \cdot {C}_{subblock}}{2 \cdot B} ) th$$
column of the circular buffer, wherein B is a constant positive integer, C_{subblock} is the number of columns of the sub-block interleaver, r is the number of the bit streams resulting from convolutional code coding, operation(•) denotes the rounding operation which is rounding-up, rounding-down or rounding-off.

10. The method according to claim 1, wherein determining the starting position for reading, from the circular buffer, the data bits forming the data packet to be transmitted comprises: determining the starting position for reading, from the circular buffer, the data bits forming the data packet to be transmitted, to be the first significant bit of the circular buffer.

11. A convolutional-code-based data sending device, comprising: a processor; and or more modules stored on a memory and executable by the processor, wherein the one or more modules comprise:
a coding and caching module, arranged to perform convolutional code coding on data bits of an input information block and arrange the coded data bits into a circular buffer;
a starting position determination module, arranged to determine a starting position for reading, from the circular buffer, data bits forming a data packet to be transmitted; and
a data reading and sending module, arranged to read data bits of a specific length column by column from the starting position according to a sequence of the columns to form a data packet to be transmitted and send the data packet to be transmitted.

12. The device according to claim 11, wherein the coding and caching module comprises:
a coder, arranged to perform convolutional code coding on the data bits of the input information block and output r check bit streams, wherein r is an integer more than or equal to 2;
sub-block interleavers, arranged to receive the check bit streams output by the coder; and
a rearrangement unit, arranged to perform inter-column rearrangement on the check bit streams input into each sub-block interleaver according to a given rearrangement vector respectively.

13. The device according to claim 12, wherein the coding and caching module comprises: a bit interleaving unit, arranged to perform bit interleaving on t rearranged check bit streams, wherein t is a positive integer, and 2≤t≤r.

14. The device according to claim 11, wherein the starting position determination module is arranged to:
according to a redundancy version value corresponding to the data packet to be formed and transmitted, determine the starting position for reading, from the circular buffer, the data bits forming the data packet to be transmitted; or,
according to data packets which have been sent, determine the starting position for reading, from the circular buffer, the data bits forming the data packet to be transmitted; or,
according to a transmission sequence corresponding to the data packet to be transmitted, determine the starting position for reading, from the circular buffer, the data bits forming the data packet to be transmitted.

15. The device according to claim 14, wherein that the starting position determination module is arranged to determine the starting position for reading, from the circular buffer, the data bits forming the data packet to be transmitted according to the redundancy version value corresponding to the data packet to be formed and transmitted comprises:
when there are Nᵣᵥ redundancy version values corresponding to the data packet to be transmitted, determining the starting position to be
$${k}_{0} = {R}_{subblock} \cdot [ A \cdot Operation ( \frac{{N}_{cb}}{{R}_{subblock} \cdot {N}_{rv} \cdot A} \cdot {rv}_{idx} ) ] ,$$
wherein R_{subblock} denotes a number of rows of the sub-block interleaver, N_{cb} denotes a size of the circular buffer, Nᵣᵥ denotes a number of the redundancy version values, Nᵣᵥ is a positive integer, rv_{idx} denotes the redundancy version value, rv_{idx} is valued from a set {0, 1, K Nᵣᵥ−1}, Operation(•) represents a rounding operation which is rounding-up, rounding-down or rounding-off, and A is a constant positive integer.

16. The device according to claim 14, wherein that the starting position determination module is arranged to determine the starting position for reading, from the circular buffer, the data bits forming the data packet to be transmitted according to the data packets which have been sent comprises:
when the current data packet to be transmitted is a data packet to be transmitted for the nth time and a length of data packets which have been sent for the last n−1 times is Ei, determining the starting position of the data bits of the current data packet to be transmitted to be k₀=R_{subblock}·mod(Cₙ₋₁,(r·C_{subblock})),
where R_{subblock} denotes a number of rows of the sub-block interleaver, C_{subblock} denotes a number of columns of the sub-block interleaver, r is a number of the bit streams resulting from convolutional code coding, mod(•) denotes a remainder calculation operation, Cₙ₋₁ denotes a number of columns of the circular buffer corresponding to the data packets which have been sent for the last n−1 times,
$${C}_{n = 1} = {\sum }_{i = 1}^{n - 1} ⌈ \frac{{E}_{i}}{{R}_{subblock}} ⌉ , or , {C}_{n - 1} = {\sum }_{i = 1}^{n - 1} ⌈ \frac{{E}_{i}}{{R}_{subblock}} ⌉ - n + 1 ,$$
wherein n and i are positive integers, 1≤i≤n−1, and ┌ ┐ denotes a rounding-up operation.

17. The device according to claim 14, wherein that the starting position determination module is arranged to determine the starting position for reading, from the circular buffer, the data bits forming the data packet to be transmitted according to the transmission sequence corresponding to the data packet to be transmitted comprises:
when the current data packet to be transmitted is the data packet to be transmitted for the nth time and when n is an odd number, determining the starting position of the current data packet to be transmitted to be a first significant bit of the circular buffer; and when n is an even number, determining the starting position of the current data packet to be transmitted to be a first significant bit of a central column of the circular buffer, wherein n is a positive integer.

18. The device according to claim 14, wherein that the starting position determination module is arranged to determine the starting position for reading, from the circular buffer, the data bits forming the data packet to be transmitted according to the transmission sequence corresponding to the data packet to be transmitted comprises:
when the current data packet to be transmitted is the data packet to be transmitted for the nth time and column indexes of the circular buffer are [0, 1, 2, . . . , r·C_{subblock}−1], where r·C_{subblock} represents a number of columns of the circular buffer, when n is an odd number, determining the starting position of the current data packet to be transmitted to be a first significant bit of a first column of the circular buffer; and when n is an even number, determining the starting position of the current data packet to be transmitted to be a first significant bit of a
$$B \cdot operation ( \frac{r \cdot {C}_{subblock}}{2 \cdot B} ) th$$
column of the circular buffer, wherein B is a constant positive integer, C_{subblock} denotes a number of columns of the sub-block interleaver, r denotes a number of the bit streams resulting from convolutional code coding, operation(•) denotes the rounding operation which is rounding-up, rounding-down or rounding-off.

19. The device according to claim 11, wherein that the starting position determination module is arranged to determine the starting position for reading, from the circular buffer, the data bits forming the data packet to be transmitted comprises: determining the starting position for reading, from the circular buffer, the data bits forming the data packet to be transmitted, to be the first significant bit of the circular buffer.
